(19) United States
(12) Patent Application Publication
(10) Pub. No.: US 2023/0300670 A1
(43) Pub. Date: Sep. 21, 2023

(54) NETWORK SLICE ANALYTICS

(71) Applicant: Samsung Electronics Co., Ltd., Suwon-si, Gyeonggi-do (KR)

(72) Inventor: David Gutierrez ESTEVEZ, Staines (GB)

(21) Appl. No.: 18/021,031

(22) PCT Filed: Aug. 13, 2021
(86) PCT No.: PCT/KR2021/010782

§ 371 Date: Feb. 13, 2023

(30) Foreign Application Priority Data
Aug. 13, 2020 (GB) 2012665.2

(51) Int. Cl. H04W 28/02; H04L 47/70; H04L 47/2425

(52) U.S. Cl. CPC H04W 28/0284; H04L 47/823; H04L 47/2425; H04W 28/0289

(57) ABSTRACT

There is disclosed a method for providing network slice analytics. The method comprises: obtaining, by a first network entity, input data from one or more data sources in the network; processing, by the first network entity, the input data to obtain output analytics; and providing the output analytics to one or more network analytics consumers. The input data may comprise information relating to one or more of: UE registrations in the network slice; PDU session establishments in the network slice; and resource utilisation in the network slice. The output analytics may comprise information relating to one or more of: UE load; PDU session load; and resource usage on a network slice.

### CROSS-REFERENCE TO RELATED APPLICATION(S)

This application is a U.S. National Stage application under 35 U.S.C. § 371 of an International application number PCT/KR2021/010782, filed on Aug. 13, 2021, which is based on and claims priority of a British patent application number 2012665.2, filed on Aug. 13, 2020, in the British Intellectual Property Office, the disclosure of which is incorporated by reference herein in its entirety.

### TECHNICAL FIELD

Certain examples of the present disclosure provide methods, apparatus and systems for providing network slice analytics. For example, certain examples of the present disclosure provide methods, apparatus and systems for providing network slice load analytics in a 3GPP 5G network based on NWDAF.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FOAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

Herein, the following documents are referenced:

[1] 3GPP TS 23.501 “System Architecture for the 5G System; Stage 2”

[2] 3GPP TS 23.288 “Architecture enhancements for 5G System (5GS) to support network data analytics services”.

[3] 3GPP TS 23.502: Procedures for the 5G System (5GS), Rel-16 (06-2020).

Various acronyms, abbreviations and definitions used in the present disclosure are defined at the end of this description.

There is an ever-increasing desire to improve the performance of communication networks so that user experience can be enhanced without the network operator investing unnecessarily in excessive equipment. In other words, network operators are keen to optimize the performance of their installed fleet of infrastructure. In the past, network optimization was largely a manually-managed process, with skilled operators adjusting network parameters as required. Over time, more automation has been introduced. More recently still, Artificial Intelligence (AI) and Machine Learning (ML) techniques have be employed. In 5th Generation (5G) networks, there are different network structures and protocols which have been employed to enhance user experience. Therefore, there is a desire to make best use of these new structures and protocols to improve network performance and/or user experience.

AI has been identified as a key enabler for end-to-end network automation in 5G in all network domains, including the domains subject to the standardization process of Radio Access Network (RAN), Core Network (CN), and Management System, also known as Operations, Administration and Maintenance (OAM). Hence, standardization and industry bodies are now in the process of developing specification support for data analytics to enable AI models assist with the ever-increasing complex task of autonomously operating and managing the network.

On the RAN side, the pioneering O-RAN alliance was established in 2018 by leading operators with the vision of developing open specifications for an open and efficient RAN that leverages AI for automating different network functions (NFs) and reducing operating expenses (OPEX). Furthermore, standardized support for data analytics by 3GPP is particularly advanced already in Rel-16 on the CN side and the control plane. A data analytics framework anchored in the new so-called network data analytics function (NWDAF), located within the 5GC as a network function following the service-based architecture principles of 5GC has been defined with the purpose of enhancing multiple control-plane functionalities of the network. Moreover, on the OAM side a management data analytics service (MDAS) is also being specified by 3GPP to assist in dealing with longer-term management aspects of the network [1]. The joint operation of RAN analytics entities, NWDAF and MDAS is still work in progress within the relevant bodies.

In 3GPP 5GS, the following are defined (e.g. in 3GPP TS 23.501). A Network Slice (NS) is defined as a logical network that provides specific network capabilities and network characteristics. A Network Slice Instance (NSI) is defined as a set of Network Function instances and the required resources (e.g. compute, storage and networking resources) which form a deployed NS. A Network Function (NF) is defined as a 3GPP adopted or 3GPP defined processing function in a network, which has defined functional behaviour and 3GPP defined interfaces. NFs in 3GPP 5GC include the NWDAF (as defined in 3GPP TS 23.288).

NWDAF represents operator managed network analytics logical function providing slice specific network data analytics to a NF. Stage 2 architecture enhancements for 5GS to support network data analytics services in 5GC are defined in 3GPP TS 23.288 (e.g. V 16.4.0). The NWDAF is part of the architecture specified in 3GPP TS 23.501 (e.g. V 16.5.1).

The NWDAF services are used to expose load level analytics from the NWDAF to the consumer NF. Analytics may be filtered by (i) Network Slice Instance, (ii) Load Level Threshold value: the NWDAF reports when the load level crosses the threshold provided in the analytics subscription; if no threshold is provided in the subscription, the reporting (Notify operation) is assumed to be periodic.

The NWDAF provides load level information to an NF on a network slice instance level. The NWDAF is not required to be aware of the current subscribers using the slice. The NWDAF notifies slice specific network status analytics information to the NFs that are subscribed to it. An NF may collect directly slice specific network status analytics information from NWDAF. This information is not subscriber specific.

What is desired is a technique to improve the provision of data analytics in a communication network, for example the provision of load data analytics per network slice leveraging NWDAF.

The above information is presented as background information only to assist with an understanding of the present disclosure. No determination has been made, and no assertion is made, as to whether any of the above might be applicable as prior art with regard to the present invention.

### DISCLOSURE OF INVENTION

### Technical Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Other aspects, advantages, and salient features will become apparent to those skilled in the art from the following detailed description, taken in conjunction with the annexed drawings, which disclose examples of the present disclosure.

### Solution to Problem

Certain examples of the present disclosure may provide network slice analytics, the method comprising: obtaining, by a first network entity (e.g. NWDAF), input data from one or more data sources in the network; processing, by the first network entity, the input data to obtain output analytics; and providing the output analytics to one or more network analytics consumers (e.g. NF), wherein the input data comprises information relating to one or more of: UE registrations in the network slice; PDU session establishments in the network slice; and resource utilisation in the network slice, and/or wherein the output analytics comprises information relating to one or more of: UE load; PDU session load; and resource usage on a network slice.

Certain examples of the present disclosure, wherein the one or more data sources include one or more of: 5GC NF; AMF; SMF; OAM; and NRF.

Certain examples of the present disclosure, wherein the input data comprises one or more of: information relating to the number of UE registrations in the network (e.g. from AMF); information relating to the number of PDU session establishments in the network (e.g. from SMF); information indicating a maximum number of UEs allowed on a network slice (e.g. from OAM); information indicating a maximum number of PDU sessions allowed on a network slice (e.g. from OAM); information indicating network slice instance resource utilisation (e.g. from OAM and/or NRF); and time information (e.g. a time stamp) associated with one or more of the above (e.g. from 5GC NF).

Certain examples of the present disclosure, wherein the output analytics are obtained per network slice and/or per network slice instance.

Certain examples of the present disclosure, wherein the output analytics comprises one or more of: information indicating UE load on a network slice instance and/or a network slice; and a number of times UE load on a network slice instance and/or a network slice exceeds a certain threshold during a certain time period.

Certain examples of the present disclosure, wherein the information indicating UE load comprises a value between a lower bound (e.g. 0) corresponding to a lower bound load (e.g. zero load) and an upper bound (e.g. 1) corresponding to an upper bound load (e.g. a UE quota for a network slice instance and/or network slice).

Certain examples of the present disclosure, wherein the output analytics comprises one or more of: information indicating PDU session load on a network slice instance and/or a network slice; and a number of times PDU session load on a network slice instance and/or a network slice exceeds a certain threshold during a certain time period.

Certain examples of the present disclosure, wherein the information indicating PDU session load comprises a value between a lower bound (e.g. 0) corresponding to a lower bound load (e.g. zero load) and an upper bound (e.g. 1) corresponding to an upper bound load (e.g. a PDU session quota for a network slice instance and/or a network slice).

Certain examples of the present disclosure, wherein the output analytics comprises one or more of: information indicating resource usage on a network slice instance and/or a network slice; and a number of times resource usage on a network slice instance and/or a network slice exceeds a certain threshold during a certain time period.

Certain examples of the present disclosure, wherein the output analytics comprises time information (e.g. one or more time stamps) indicating one or more times: a UE load on a network slice instance and/or a network slice; a PDU session load on a network slice instance and/or a network slice; and/or a resource usage on a network slice instance and/or a network slice, exceeds a corresponding threshold.

Certain examples of the present disclosure, wherein the output analytics comprises one or more of: information identifying one or more network slices corresponding to the output analytics; information identifying one or more network slice instances corresponding to the output analytics; and information indicating a list of one or more network slice instances within a network slice corresponding to the output analytics.

Certain examples of the present disclosure, wherein the output analytics comprise statistics and/or predictions.

Certain examples of the present disclosure, wherein the one or more network analytics consumers comprise one or more of: PCF; CHF; NSSF; and AMF.

Certain examples of the present disclosure, wherein the output analytics are obtained by applying one or more analytics filters (e.g. specified in an analytics subscription request message).

Certain examples of the present disclosure, wherein the one or more analytics filters are applied based on one or more of: identification of one or more network slices (e.g. S-NSSAI); identification of one or more network slice instances (e.g. NSI ID); one or more load level threshold values; one or more areas of interest (e.g. TAI); and one or more GST parameters of interest.

Certain examples of the present disclosure, wherein the method further comprises receiving a message (e.g. subscription request message) from a network analytics consumer requesting network analytics.

Certain examples of the present disclosure, wherein obtaining the input data comprises: subscribing to input data (e.g. network slice quotas for UEs and PDU sessions and/or resource usage related information for a network slice instance) from OAM; subscribing to input data (e.g. number of UEs currently registered on a certain network slice) from AMF; and/or subscribing to input data (e.g. number of PDU sessions currently registered on a certain network slice) from SMF.

Certain examples of the present disclosure, wherein obtaining the input data comprises: obtaining, from NRF, information of one or more network entity (e.g. AMF, SMF and/or NSSF) instances relevant to one or more specified analytics filters; obtaining, from NSSF, one or more network slice instance identities corresponding to a specified network slice; and/or obtaining, from NRF, information for deriving resource usage analytics (e.g. for a network slice instance).

Certain examples of the present disclosure, a first network entity (e.g. NWDAF) configured to operate according to any of the examples.

Certain examples of the present disclosure, a network comprising a first network entity, one or more data sources, and one or more network analytics consumers.

Certain examples of the present disclosure, a computer program comprising instructions which, when the program is executed by a computer or processor, cause the computer or processor to carry out a method according to any of the above examples.

Certain examples of the present disclosure, a computer or processor-readable data carrier having stored thereon a computer program.

### BRIEF DESCRIPTION OF DRAWINGS

FIG. 1 illustrates an exemplary procedure to support NWDAF-based slice load analytics.

FIG. 2 is a block diagram of an exemplary network entity that may be used in certain examples of the present disclosure.

FIG. 3 is a flowchart for certain examples of a network data analytics function (NWDAF).

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim of the present invention are to be understood to be applicable to any other aspect, embodiment, example or claim described herein unless incompatible therewith.

Certain examples of the present disclosure provide methods, apparatus and systems for providing network slice analytics. The following examples are applicable to, and use terminology associated with, 3GPP 5G. For example, certain examples of the present disclosure provide methods, apparatus and systems for providing network slice analytics in a 3GPP 5G network based on NWDAF. However, the skilled person will appreciate that the techniques disclosed herein are not limited to these examples or to 3GPP 5G, and may be applied in any suitable system or standard, for example one or more existing and/or future generation wireless communication systems or standards.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of the NWDAF in the examples below may be applied to any other suitable type of entity providing network analytics.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Certain examples of the present disclosure may be provided in the form of a system (e.g. a network) comprising one or more such apparatuses/devices/network entities, and/or a method therefor.

A network may include one or more of a Network Data Analytics Function (NWDAF) entity, an Access and Mobility Management Function (AMF) entity, a Session Management Function (SMF) entity, a Network Slice Selection Function (NSSF) entity, a Network Repository Function (NRF) entity, and an Operation and Maintenance (OAM) entity. The network may include one or more Service Consumers (including one or more of the entities mentioned above and/or one or more other entities) that receive analytics from NWDAF. The skilled person will appreciate that a network may omit one or more of the entities mentioned above and/or may comprise one or more additional entities.

A particular network function can be implemented either as a network element on a dedicated hardware, as a software instance running on a dedicated hardware, or as a virtualised function instantiated on an appropriate platform, e.g. on a cloud infrastructure. An NF service may be defined as a functionality exposed by an NF through a service based interface and consumed by other authorized NFs.

A mentioned above, what is desired is a technique to improve the provision of data analytics in a communication network, for example the provision of load data analytics per network slice leveraging NWDAF.

Certain examples of the present disclosure addresses a problem in the context of network automation, namely the utilization of data analytics for slice service level agreement (SLA) guarantee. Hence, certain examples of the present disclosure provide the capability for a service consumer to subscribe to such analytics and receive statistics and/or predictions on the load of a slice.

Slice load level data analytics as described in Rel-16 TS 23.288 [2] refer to network slice instance level and are provided in two possible formats: (i) when a load threshold is provided as analytic filter by the consumer NF in the slice load subscription message, NWDAF informs the consumer NF of such threshold crossings each time they happen, and (ii) when no load threshold is provided by the consumer NF, NWDAF provides periodic notifications to the consumer NF reporting the network slice instance load.

There are a number of problems with the current status of the network slice instance load analytics specification:
It is not clear which metric should be used to represent network slice instance load values and how to derive such values. For example, load could be measured in terms of UE registrations, PDU sessions, resource utilization, etc. Even if the derivation itself is left as implementation specific, the specification should provide support for such functionality, e.g. if the network slice instance load is assumed to be derivable from NF load values in a proprietary way.
It is currently unclear whether load should be determined per network slice instance and/or network slice.

NWDAF is supposed to provide statistics and predictions for each analytics type. However, it is currently unclear whether in the case of network slice instance load statistics and predictions would be provided at all, and if so whether they would be provided for load values directly and/or for load threshold crossings.

Several network-related functionalities (e.g. slice SLA guarantee, slice load distribution) would greatly benefit from using slice load data analytics provided by NWDAF. Hence, certain examples of the present disclosure provide a spectrum of network optimizations by providing the specification of slice load analytics, currently missing in the related specification [2].

In certain examples of the present disclosure, Network Slice load analytics are specified by specifying the input data, output analytics, and procedures for data analytics types.

A general description of certain examples will first be described, which may include one or more of the following.

In certain examples, the NWDAF may provide slice load level information (e.g. statistics and/or predictions) to an NF on a Network Slice instance level based on the number of UEs and/or PDU sessions subscribed to the slice instance.

In certain examples, NWDAF may provide information on resource usage based on input data from OAM.

In certain examples, NWDAF may provide information on load for the whole Network Slice.

In certain examples, the NWDAF may not be required to be aware of the identity of the subscribers using the slice. The NWDAF may notify slice specific network status analytics information to the NFs that are subscribed to it. An NF may collect directly slice specific network status analytics information from NWDAF. This information may not be subscriber specific.

In certain examples, the NWDAF services, for example as defined in clause 7.2 and clause 7.3 of TS 23.288 [2], may be used to expose slice load level analytics from the NWDAF to a consumer NF (e.g. PCF, CHF, NSSF, AMF).

In certain example, one or more of the following Analytics ID may be used for the slice load level related network data analytics:
Load level information

In certain examples, one or more of the following Analytics Filters may be included by the consumer in the related messages (e.g. Nnwdaf_AnalyticsSubscription_Subscribe and Nnwdaf_AnalyticsInfo_Request service operation):
S-NSSAI and NSI ID
Load Level Threshold value(s)
Area of Interest, i.e. TAI(s) of the geographic area of interest
GST Parameter(s) of Interest

In certain examples, the use of NSI ID in the network may be optional and may depend on the deployment choices of the operator. If used, the NSI ID is associated with S-NSSAI.

In certain examples, the GST parameter(s) Analytics Filter may refer to number of terminals, number of connections (i.e. PDU sessions), or both.

Next will be described an exemplary specification of input data and output analytics.

### Input Data

Certain examples of the present disclosure may use one or more pieces of input data indicated in Table 1 below. The skilled person will appreciate that the exact form of the input data, and/or the sources of such information, is not necessarily limited to the specific examples indicated in Table 1.

TABLE 1

| Information | Source(s) | Description |
|---|---|---|
| Timestamps | 5GC NF | A time stamp associated with |
| | | the collected information. |
| UE registrations on a Network | AMF* | Data sent to NWDAF for UE |
| Slice/Network Slice instance | | registrations |
| PDU session establishments on | SMF * | Data sent to NWDAF for |
| a Network Slice/Network Slice | | of PDU session establishments |
| instance | | |
| Quota for number of UEs on a | OAM* | Maximum number of UEs |
| Network Slice | | allowed on a Network Slice |
| Quota for number of PDU | OAM* | Maximum number of PDU |
| Sessions on a Network Slice | | sessions allowed on a Network |
| | | Slice |
| Resource utilization of | OAM, | Network Slice instance resource |
| Network Slice instance | NRF | utilization information |

Table 1 indicates possible source entities for input data collection, which may be regarded as reliable input data sources for the identified data. However, in certain examples, entries in Table 1 where source entities are starred (*), namely AMF, SMF and OAM, may be replaced by fewer entities, for example a single entity (including the three of them) which would contain all the four input data types in the table as a way to simplify signalling overhead of data collection procedures. Various examples of the present disclosure may account for the (e.g. default) configuration above, and any other possible optimization.

In certain examples, in the resource utilization of a Network Slice instance, NWDAF may collect the data directly from OAM. Alternatively, it may receive from OAM the list of constituent NF instance identifiers for the Network Slice instance, and NWDAF may contact NRF to obtain resource utilization data for each of the NF instances whose identifiers were provided by OAM.

Rel-16 allowed NWDAF to provide threshold-based notifications (i.e. a notification is sent whenever a load threshold is reached in the network slice instance). However, it was not specified what metric the load threshold refers to (e.g. resource utilization, UE registrations, PDU sessions, etc.), so its implementation was not feasible. In addition, a ‘periodic’ notification was supposedly enabled, but there is no specification as to what the notification would refer to, since load is an abstract concept.

Certain examples of the present disclosure extend the above mentioned concept in two ways:
Threshold-based notifications may still be delivered by NWDAF whenever the service consumer indicates that it is output format it is interested in.
If the service consumer is interested in receiving NWDAF-compliant statistics and/or predictions like the rest of data analytics (whether periodic or one-off), then the below specification may be applied.

If threshold(s) is/are used to produce the analytics, the threshold value(s) may be provided by the service consumer. If no threshold is provided, the threshold-related output analytics may be omitted.

### Output Analytics

Certain examples of the present disclosure may generate one or more pieces of output analytics according to Table 2. The skilled person will appreciate that the exact form of the output analytics is not necessarily limited to the specific examples indicated in Table 2.

TABLE 2

| Information | Description |
|---|---|
| S-NSSAI | Identification of the Network Slice |
| Network Slice instances | List of Network Slice instance(s) with |
| (1, . . . , max) | the S-NSSAI |
| >NSI ID | Identification of the Network Slice |
| | instance |
| > NSI UE load | UE load on a Network Slice instance |
| | expressed as a value between 0 and 1 |
| | represents reaching the UE quota for the |
| | Network Slice |
| >NSI UE load threshold | Number of UE threshold crossings on a |
| crossings | Network Slice instance during analytics |
| | target period |
| >NSI UE threshold crossings | UE load threshold crossing vector |
| | including a timestamp for each threshold |
| | crossing on the Network Slice instance |
| >NSI UE threshold crossings | PDU session load on a Network Slice |
| timestamps (1, . . . , max) | instance expressed as a value between 0 |
| | and 1 where 1 represents reaching the PDU |
| | session quota for the network slice |
| >NSI PDU session theshold | Number of PDU session threshold |
| crossings | crossings on a Network Slice instance |
| | during analytics target period |
| >NSI PDU session threshold | PDU session threshold crossing vector |
| crossings timestamps | including a timestamp crossing on the |
| (1, . . . , max) | Network slice instance |

In certain examples, if multiple Network Slice instances are not deployed for the S-NSSAI or NSI IDs are not available, only one Slice instance service experience entry may be provided. In that case, the NSI ID may not be provided and the Slice instance service experience may indicate the service experience for the S-NSSAI.

In certain examples of the present disclosure, output analytics may additionally or alternatively include one or more of the items indicated in Table 3 and/or Table 4 below:

1) Output analytics on resource usage per Network Slice instance:

TABLE 3

| >Resource usage | Resource usage of a Network Slice instance |
|---|---|
| >Resource usage threshold | Number of resource usage threshold |
| crossings | crossings on the Network Slice instance |
| Resource usage threshold | Resoure Usage threshold crossing vector |
| crossings timestamps | including a timestamp for each threshold |
| (1, . . . , max) | crossing on the Network Slice instance |

2) Per Network Slice (i.e. S-NSSAI) output analytics as follows:

TABLE 4

| S-NSSAI | |
|---|---|
| > UE load | UE load on a Network Slice expressed as a |
| | value between 0 and 1 where 1 represents |
| | reaching the UE quota for the Network |
| | Slice |
| > UE threshold crossings | Number of UE threshold crossings on a |
| | Network Slice during analytics target |
| | period |
| > UE threshold crossings | UE load threshold crossing vector |
| timestamps (1, . . . , max) | including a timestamp for each threshold |
| | crossing on the Network Slice |
| > PDU session load | PDU session load on a Network Slice |
| | expressed as a value between 0 and 1 |
| | where 1 represents reaching the PDU |
| | session quota for the Network Slice |
| > PDU Session threshold | Number of PDU Session threshold |
| crossings | crossings on a Network Slice during |
| | analytics target period |
| > PDU Session threshold | PDU Session threshold crossing vector |
| crossings timestamps | including a timestamp for each threshold |
| (1, . . . , max) | crossing on the Network Slice |

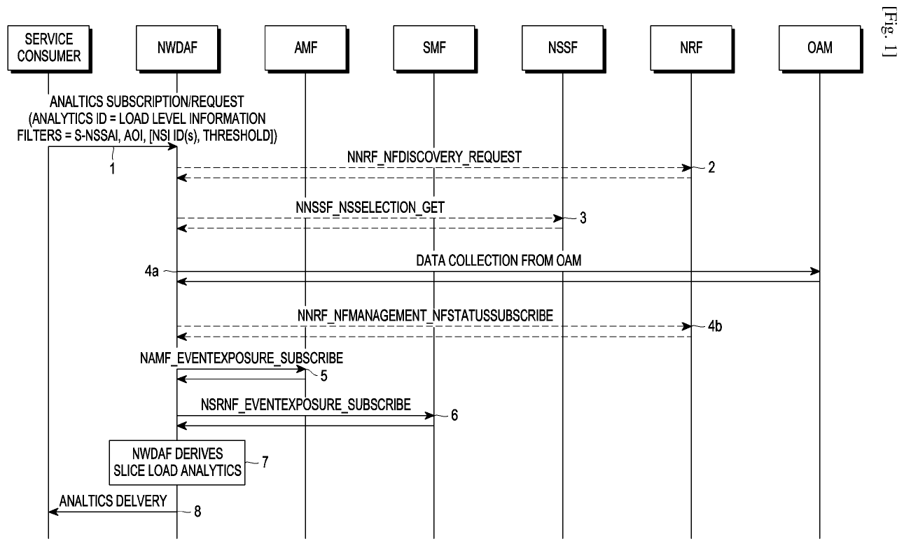

Next, an exemplary procedure for NWDAF to derive slice load analytics is described with reference to FIG. 1. The various operations in the procedure are described below. In various examples, certain operations (e.g. those indicated with dotted arrows) may be omitted. The skilled person will appreciate that the present disclosure is not limited to the specific example of FIG. 1.

1. The service consumer may subscribe to slice load analytics, for example via the Nnwdaf_AnalyticsSubscription_Subscribe or Nnwdaf_AnalyticsInfo_Request service operations. In addition, the service consumer may provide various information, for example “Analytics ID=Load level information” and a set of Event Filters. Analytics Filters (e.g. Mandatory Analytics Filters) may include S-NSSAI and Area of Interest. Other filters (e.g. optional event filters) may include one or more NSI ID(s) and the load threshold value(s).

2. [OPTIONAL] If NWDAF does not have already the information, it may discover, e.g. from NRF, the AMF, SMF and NSSF instance(s) relevant to the Analytics Filters provided in the analytics subscription.

3. [OPTIONAL] If the NSI ID(s) are not provided in the analytics subscription by the service consumer, NWDAF may invoke an operation (e.g. Nnssf_NS Selection_Get service operation) from NSSF to obtain the NSI ID(s) corresponding to the S-NSSAI in the subscription.

4a. NWDAF may subscribe to input data from OAM, for example following the procedure defined in Clause 6.2.3.2. of TS 23.288 [2]. The input data may include, for example, Network Slice quotas for UEs and PDU sessions as well as resource usage related information for the Network Slice instance(s) and/or its constituent NF instances.

4b. [OPTIONAL] NWDAF may collect input data from NRF (for example, see Table 6.5.2-1 in TS 23.288 [2]) to derive slice instance resource usage statistics and predictions for a Network Slice instance.

5. NWDAF may subscribe to AMF's event exposure service to collect data on the number of UEs currently registered on certain Network Slice and, if available, its constituent Network Slice instance(s). An UE access and mobility information event may be used for that purpose, for example as defined in TS 23.502 [3] using as Event Filters S-NSSAI and, if available, NSI ID(s). If required, NWDAF may also collect the corresponding UE IDs.

6. NWDAF may subscribe to SMF's event exposure service to collect data on the number of PDU sessions currently registered on certain Network Slice and, if available, its constituent Network Slice instance(s). A PDU Session related event may be used for that purpose, for example as defined in TS 23.502 [3]. Possible Event Filters include S-NSSAI, NSI ID(s), UE IDs, etc.

7. NWDAF derives slice load analytics.

8. NWDAF delivers analytics to the service consumer, for example by invoking Nnwdaf_AnalyticsSubscription_Notify or Nnwdaf_AnalyticsInfo_Request response service operations.

Certain examples of the present disclosure provide a method for providing network slice analytics, the method comprising: obtaining, by a first network entity (e.g. NWDAF), input data from one or more data sources in the network; processing, by the first network entity, the input data to obtain output analytics; and providing the output analytics to one or more network analytics consumers (e.g. NF), wherein the input data comprises information relating to one or more of: UE registrations in the network slice; PDU session establishments in the network slice; and resource utilisation in the network slice, and/or wherein the output analytics comprises information relating to one or more of: UE load; PDU session load; and resource usage on a network slice.

In certain examples, the one or more data sources may include one or more of: 5GC NF; AMF; SMF; OAM; and NRF.

In certain examples, the input data may comprise one or more of: information relating to the number of UE registrations in the network (e.g. from AMF); information relating to the number of PDU session establishments in the network (e.g. from SMF); information indicating a maximum number of UEs allowed on a network slice (e.g. from OAM); information indicating a maximum number of PDU sessions allowed on a network slice (e.g. from OAM); information indicating network slice instance resource utilisation (e.g. from OAM and/or NRF); and time information (e.g. a time stamp) associated with one or more of the above (e.g. from 5GC NF).

In certain examples, the output analytics are obtained per network slice and/or per network slice instance.

In certain examples, the output analytics may comprise one or more of: information indicating UE load on a network slice instance and/or a network slice; and a number of times UE load on a network slice instance and/or a network slice exceeds a certain threshold during a certain time period.

In certain examples, the information indicating UE load may comprise a value between a lower bound (e.g. 0) corresponding to a lower bound load (e.g. zero load) and an upper bound (e.g. 1) corresponding to an upper bound load (e.g. a UE quota for a network slice instance and/or network slice).

In certain examples, the output analytics may comprise one or more of: information indicating PDU session load on a network slice instance and/or a network slice; and a number of times PDU session load on a network slice instance and/or a network slice exceeds a certain threshold during a certain time period.

In certain examples, the information indicating PDU session load may comprise a value between a lower bound (e.g. 0) corresponding to a lower bound load (e.g. zero load) and an upper bound (e.g. 1) corresponding to an upper bound load (e.g. a PDU session quota for a network slice instance and/or a network slice).

In certain examples, the output analytics may comprise one or more of: information indicating resource usage on a network slice instance and/or a network slice; and a number of times resource usage on a network slice instance and/or a network slice exceeds a certain threshold during a certain time period.

In certain examples, the output analytics may comprise time information (e.g. one or more time stamps) indicating one or more times: a UE load on a network slice instance and/or a network slice; a PDU session load on a network slice instance and/or a network slice; and/or a resource usage on a network slice instance and/or a network slice, exceeds a corresponding threshold.

In certain examples, the output analytics may comprise one or more of: information identifying one or more network slices corresponding to the output analytics; information identifying one or more network slice instances corresponding to the output analytics; and information indicating a list of one or more network slice instances within a network slice corresponding to the output analytics.

In certain examples, the output analytics may comprise statistics and/or predictions.

In certain examples, the one or more network analytics consumers may comprise one or more of: PCF; CHF; NSSF; and AMF.

In certain examples, the output analytics may be obtained by applying one or more analytics filters (e.g. specified in an analytics subscription request message).

In certain examples, the one or more analytics filters may be applied based on one or more of: identification of one or more network slices (e.g. S-NSSAI); identification of one or more network slice instances (e.g. NSI ID); one or more load level threshold values; one or more areas of interest (e.g. TAI); and one or more GST parameters of interest.

In certain examples, the method may further comprise receiving a message (e.g. subscription request message) from a network analytics consumer requesting network analytics.

In certain examples, obtaining the input data may comprise: subscribing to input data (e.g. network slice quotas for UEs and PDU sessions and/or resource usage related information for a network slice instance) from OAM; subscribing to input data (e.g. number of UEs currently registered on a certain network slice) from AMF; and/or subscribing to input data (e.g. number of PDU sessions currently registered on a certain network slice) from SMF.

In certain examples, obtaining the input data may comprise: obtaining, from NRF, information of one or more network entity (e.g. AMF, SMF and/or NSSF) instances relevant to one or more specified analytics filters; obtaining, from NSSF, one or more network slice instance identities corresponding to a specified network slice; and/or obtaining, from NRF, information for deriving resource usage analytics (e.g. for a network slice instance).

Certain examples of the present disclosure provide a first network entity (e.g. NWDAF) configured to operate according to any example disclosed herein.

Certain examples of the present disclosure provide a network comprising a first network entity according to the preceding example, one or more data sources, and one or more network analytics consumers.

Certain examples of the present disclosure provide a computer program comprising instructions which, when the program is executed by a computer or processor, cause the computer or processor to carry out a method according to any example disclosed herein.

Certain examples of the present disclosure provide a computer or processor-readable data carrier having stored thereon a computer program according to the preceding example.

Certain examples of the present disclosure provide a unit for use in a communication network operable to receive input from at least one data source related to a network slice, process the received input data, and output slice load data analytics related to the network slice.

Certain examples of the present disclosure provide methods and apparatus for the provision of the data analytics per network slice and network slice instance, so that improvements of network performance and user experience can be achieved.

In certain examples, the unit is a network data analytics function (NWDAF).

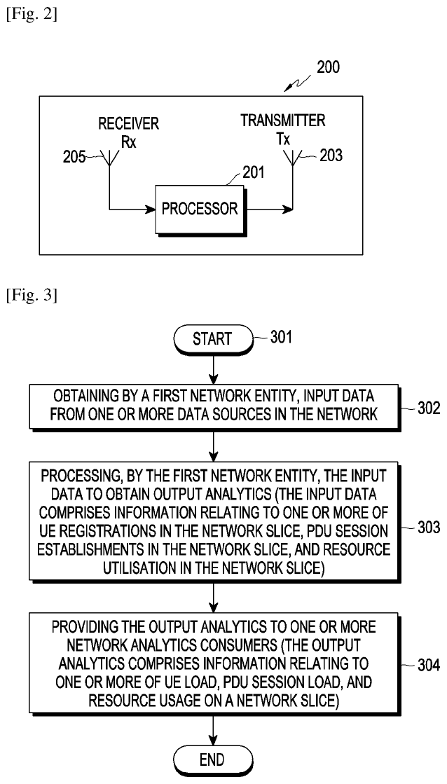

FIG. 2 is a block diagram of an exemplary network entity that may be used in examples of the present disclosure. For example, a Service Consumer, NWDAF, AMF, SMF, NSSF, NRF, OAM and/or other NFs may be provided in the form of the network entity illustrated in FIG. 2. The skilled person will appreciate that the network entity illustrated in FIG. 2 may be implemented, for example, as a network element on a dedicated hardware, as a software instance running on a dedicated hardware, or as a virtualised function instantiated on an appropriate platform, e.g. on a cloud infrastructure.

The entity 200 comprises a processor (or controller) 201, a transmitter 203 and a receiver 205. The receiver 205 is configured for receiving one or more messages or signals from one or more other network entities. The transmitter 203 is configured for transmitting one or more messages or signals to one or more other network entities. The processor 201 is configured for performing one or more operations and/or functions as described above. For example, the processor 201 may be configured for performing the operations of a Service Consumer, NWDAF, AMF, SMF, NSSF, NRF, OAM and/or other NFs.

FIG. 3 is a flow for certain examples, the unit is a network data analytics function (NWDAF). For the provision of the data analytics per network slice and network slice instance, the NWDAF may obtain(302) by a first network entity, input data from one or more data sources in the network, process(303), by the first network entity, the input data to obtain output analytics (the input data comprises information relating to one or more of UE registrations in the network slice, PDU session establishments in the network slice, and resource utilisation in the network slice) and provide(304) the output analytics to one or more network analytics consumers (the output analytics comprises information relating to one or more of UE load, PDU session load, and resource usage on a network slice).

The method and apparatus of the NWDAF may further be configured to receive a message from a network analytics consumer requesting network analytics.

The method and apparatus of the NWDAF may further be configured to receive a message from a network analytics consumer requesting network analytics.

The method and apparatus of the NWDAF may further be configured to subscribe to input data from OAM, AMF or SMF.

The method and apparatus of the NWDAF may further be configured to obtain from NRF, information of one or more network entity instances relevant to one or more specified analytics filters or from NSSF, one or more network slice instance identities corresponding to a specified network slice, or from NRF, information for deriving resource usage analytics.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain example provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by any appended claims.

### ACRONYMS, ABBREVIATIONS AND DEFINITIONS

In the present disclosure, the following acronyms, abbreviations and definitions may be used.

3 GPP 3rd Generation Partnership Project

5G 5th Generation

5 GC 5G Core Network

5GS 5G System

AI Artificial Intelligence

AMF Access and Mobility Management Function

CHF Charging Function

CN Core Network

GST Generic Slice Template

ID Identifier/Identity

MDAS Management Data Analytics Service

ML Machine Learning

NF Network Function

NRF Network Repository Function

NWDAF Network Data Analytics Function

NS Network Slice

NSI Network Slice Instance

NSSF Network Slice Selection Function

OAM Operation and Maintenance

OPEX Operating Expenses

PCF Policy Control Function

PDU Protocol Data Unit

RAN Radio Access Network

Rel Release

SLA Service Level Agreement

SMF Session Management Function

S-NSSAI Single Network Slice Selection Assistance Information

TAI Tracking Area Identity

TS Technical Specification

UE User Equipment

1. A method for providing network slice analytics, the method comprising:
obtaining, by a first network entity, input data from one or more data sources in the network;
and
providing output analytics to one or more network analytics consumers,
wherein the input data comprises information relating to one or more of:
a number of User Equipment (UE) registrations in the network slice;
a number of Protocol Data Unit (PDU) session establishments in the network slice; and
resource utilisation in the network slice, and
wherein the output analytics comprises information relating to one or more of:
a UE;
a PDU session; and
resource usage on a network slice.

2. The method according to claim 1, wherein the one or more data sources include one or more of: 5G Core Network (5GC) Network Function (NF); Access and Mobility Management Function (AMF); Session Management Function (SMF); Operation and Maintenance (OAM); and Network Repository Function (NRF).

3. The method according to claim 1, wherein the input data comprises one or more of:
information indicating a maximum number of UEs allowed on a network slice;
information indicating a maximum number of PDU sessions allowed on a network slice;
information indicating network slice instance resource utilisation; and
time information associated with one or more of the above.

4. The method according to claim 1, wherein the output analytics are obtained per network slice or per network slice instance.

5. The method according to claim 1, wherein the output analytics comprises one or more of:
information related to the UE on a network slice instance or the network slice; and
a number of times the UE on the network slice instance or the network slice exceeds a certain threshold during a certain time period.

6. The method according to claim 1, wherein the output analytics comprises one or more of:
information related to the PDU session load on a network slice instance or the network slice; and
a number of times the PDU session load on the network slice instance or the network slice exceeds a certain threshold during a certain time period.

7. The method according to claim 1, wherein the output analytics comprises one or more of:
information indicating the resource usage on the network slice instance or a network slice; and
a number of times the resource usage on the network slice instance or the network slice exceeds a certain threshold during a certain time period.

8. The method according to claim 1, wherein the output analytics comprises one or more of:
information identifying one or more network slices corresponding to the output analytics;
information identifying one or more network slice instances corresponding to the output analytics; and
information indicating a list of one or more network slice instances within a network slice corresponding to the output analytics.

9. The method according to claim 1, wherein the one or more network analytics consumers comprise one or more of: Policy Control Function (PCF); Charging Function (CHF); Network Slice Selection Function (NSSF); and AMF.

10. The method according to claim 1, wherein the output analytics are obtained by applying one or more analytics filters, and
wherein the one or more analytics filters are applied based on one or more of:
identification of one or more network slices;
identification of one or more network slice instances;
one or more load level threshold values;
one or more areas of interest; and
one or more GST parameters of interest.

11. The method according to claim 1, further comprises:
receiving a message from a network analytics consumer requesting network analytics.

12. The method according to claim 1, wherein obtaining the input data comprises:
subscribing to input data from OAM;
subscribing to input data from AMF; or
subscribing to input data from SMF.

13. The method according to claim 1, wherein obtaining the input data comprises:
obtaining, from NRF, information of one or more network entity instances relevant to one or more specified analytics filters;
obtaining, from NSSF, one or more network slice instance identities corresponding to a specified network slice; or
obtaining, from NRF, information for deriving resource usage analytics.

14. A network for providing network slice analytics, the network comprising:
a first network entity,
a one or more data sources, and
one or more network analytics consumers,.
wherein the first network entity is configured to:
obtain input data from one or more data sources in the network, and
provide output analytics to one or more network analytics consumers,
wherein the input data comprises information relating to one or more of:
a number of User Equipment (UE) registrations in the network slice,
a number of Protocol Data Unit (PDU) session establishments in the network slice, and
resource utilisation in the network slice, and
wherein the output analytics comprises information relating to one or more of:
a UE,
a PDU session, and
resource usage on a network slice.

15. (canceled)

16. The network according to claim 14, wherein the one or more data sources include one or more of: 5G Core Network (5GC) Network Function (NF); Access and Mobility Management Function (AMF); Session Management Function (SMF); Operation and Maintenance (OAM); and Network Repository Function (NRF).

17. The network according to claim 14, wherein the input data comprises one or more of:
information indicating a maximum number of UEs allowed on a network slice;
information indicating a maximum number of PDU sessions allowed on a network slice;
information indicating network slice instance resource utilisation; and
time information associated with one or more of the above.

18. The network according to claim 14, wherein the output analytics are obtained per network slice or per network slice instance.

19. The network according to claim 14, wherein the one or more network analytics consumers comprise one or more of: Policy Control Function (PCF); Charging Function (CHF); Network Slice Selection Function (NSSF); and AMF.

20. The network according to claim 14,
wherein the output analytics are obtained by applying one or more analytics filters, and
wherein the one or more analytics filters are applied based on one or more of:
identification of one or more network slices,
identification of one or more network slice instances,
one or more load level threshold values,
one or more areas of interest, and
one or more GST parameters of interest.

21. The network according to claim 14, further comprising:
receiving a message from a network analytics consumer requesting network analytics.
